(19) United States
(12) Patent Application Publication
(10) Pub. No.: US 2011/0172367 A1
(43) Pub. Date: Jul. 14, 2011

(54) Grafted Polyethylene

(76) Inventors: Michael Backer, Barry (GB); Francois De Buyl, Hoeilaart (BE)

(21) Appl. No.: 13/001,660

(22) PCT Filed: Jul. 2, 2009
(86) PCT No.: PCT/EP2009/004797

§ 371 Date: Mar. 23, 2011

(30) Foreign Application Priority Data
Jul. 3, 2008 (GB) GB0812187.3
Mar. 23, 2009 (US) 61162380
Jul. 2, 2009 (EP) PCT/EP2009/004797

(51) Int. Cl. C08F 8/00

(52) U.S. Cl. 525/254; 525/288; 525/263

(57) ABSTRACT

A process for grafting hydrolysable silane groups to polyethylene includes reacting polyethylene with an unsaturated silane having at least one hydrolysable group bonded to Si, in the presence of a compound capable of generating free radical sites in the polyethylene. The grafted polyethylene prepared by the process can be shaped into a pipe and crosslinked by water flowing through the pipe.

This invention relates to a process of grafting hydrolysable and crosslinkable groups onto polyethylene and to the graft polymers produced, and to a process of crosslinking the grafted polyethylene. In particular it relates to a process of grafting hydrolysable silane groups onto polyethylene.

EP 0245938, GB 2192891, U.S. Pat. No. 4,921,916, EP1354912 and EP1050548 describe processes involving reaction of a vinyl silane with a polymer.

U.S. Pat. No. 3,646,155 describes crosslinking of polyolefins, particularly polyethylene, by reaction (grafting) of the polyolefin with an unsaturated hydrolysable silane at a temperature above 140° C. and in the presence of a compound capable of generating free radical sites in the polyolefin. Subsequent exposure of the reaction product to moisture and a silanol condensation catalyst effects crosslinking. This process has been extensively used commercially. EP-B-809672, EP-A-1323779 and U.S. Pat. No. 7,041,744 are further examples of patents describing this grafting and crosslinking process where the unsaturated hydrolysable silane used is generally vinyltrimethoxysilane. U.S. Pat. No. 6,864,323 teaches to improve scorching performance by adding a small amount of a further compound, called compound (iii) which may be a conjugated hydrocarbon and/or at least one organofunctional silane of the general formula R-Xn-C(R)═C(R)—C(R)═C(R)-Xn-Si(R1)m(OR2)(3-m). The groups R are identical or different and R is a hydrogen atom or an alkyl group having from 1 to 3 carbon atoms or an aryl group or an aralkyl group, preferably a methyl group or a phenyl group, R(1) is a linear or branched alkyl group having from 1 to 4 carbon atoms, R(2) is a linear, branched, or cyclic alkyl group having from 1 to 8 carbon atoms, preferably a methyl, ethyl, n-propyl, or isopropyl group, the groups X are identical or different, and X is a group selected from the series —CH2-, —(CH2)2-, —(CH2)3-, —O(O)C(CH2)3- and —C(O)O—(CH2)3-, and n is 0 or 1, and m is 0, 1, 2 or 3.

One important use of crosslinked polyethylene is in pipes for carrying water. The polyethylene grafted with silane can be mixed with the condensation catalyst and extruded to form pipe, and the pipe is then exposed to moisture, for example by flowing water through and around the pipe. However it may take hours or even days to effect sufficient crosslinking to give the required resistance to heat and chemicals and mechanical properties, and to reduce the volatile organic content of the pipe to an acceptably low level. There is a requirement for a more rapid and thorough polyethylene crosslinking process, especially for pipes which are to carry drinking water.

The object of the present invention is to provide a silane-modified polyethylene having a high efficiency of grafting. In one embodiment, the high grafting efficiency is leading to a silane-modified polyethylene that can be crosslinked faster even in absence of additional catalyst typically used for crosslinking silyl-alkoxy functional groups, and in which the volatile organics content can be significantly reduced.

A process according to the invention for grafting hydrolysable silane groups to polyethylene by reacting polyethylene at a temperature above 140° C. with an unsaturated silane, having at least one hydrolysable group bonded to Si, in the presence of a compound or means capable of generating free radical sites in the polyethylene, is characterized in that the silane has the formula R″—CH═CH—Z (I) or R″—C≡C—Z (II) in which Z represents an electron-withdrawing moiety substituted by a —SiRₐR′₍₃₋ₐ₎ group wherein R represents a hydrolysable group; R′ represents a hydrocarbyl group having 1 to 6 carbon atoms; a has a value in the range 1 to 3 inclusive; and R″ represents hydrogen or a group having an electron withdrawing or any other activation effect with respect to the —CH═CH— or —C═C— bond.

We have found according to the invention that the use of an unsaturated hydrolysable silane, i.e. an unsaturated silane having at least one hydrolysable group bonded to Si of the formula R″—CH═CH—Z (I) or R″—C═C—Z (II) in carrying out the grafting reaction on polyethylene gives enhanced grafting yield compared to grafting with an hydrolysable olefinically unsaturated silane such as vinyltrimethoxysilane not containing an electron-withdrawing moiety Z. The enhanced grafting leads to more thorough crosslinking of the polyethylene in a shorter period of time in the presence of moisture and a condensation catalyst—although this latter was not always necessary, and to reduced total organic carbon content of water circulating into pipe section fabricated using the enhanced grafted polyethylene.

In one of its aspects, the invention provide a process for grafting hydrolysable silane groups to polyethylene is provided, which process includes reacting polyethylene with particularly reactive unsaturated silane towards grafting reaction to polyethylene, having at least one hydrolysable group bonded to Si, in the presence of a compound capable of generating free radical sites in the polyethylene. The grafted polyethylene prepared by the process can be shaped into any particular part, for instance a pipe and crosslinked by water flowing through the pipe for example according to either Sioplas® or Monosil® process. An electron-withdrawing moiety is a chemical group which draws electrons away from a reaction center. The electron-withdrawing moeity Z can in general be any of the groups listed as dienophiles in Michael B. Smith and Jerry March; March's Advanced Organic Chemistry, 5^{th} edition, John Wiley & Sons, New York 2001, at Chapter 15-58 (page 1062) provided that the groups are capable of being substituted by a —SiRₐR′₍₃₋ₐ₎ group. The moiety Z can be a C(═O)R*, C(═O)OR*, OC(═O)R*, C(═O)Ar moiety in which Ar represents arylene substituted by a —SiRₐR′₍₃₋ₐ₎ group and R* represents a hydrocarbon moiety substituted by a —SiRₐR′₍₃₋ₐ₎ group. Z can also be a C(═O)—NH—R* moiety. Preferred silanes include those of the form R″—CH═CH—X—Y—SiRₐR′₍₃₋ₐ₎ (III) or R″—C≡C—X—Y—SiRₐR′₍₃₋ₐ₎ (IV) in which X represents a chemical linkage having an electron withdrawing effect with respect to the —CH═CH— or a —C≡C— bond such as a carboxyl, carbonyl, or amide linkage, and Y represents a divalent organic spacer linkage comprising at least one carbon atom separating the linkage X from the Si atom.

Electron-donating groups, for example alcohol group or amino group may decrease the electron withdrawing effect. In one embodiment, unsaturated silane (I) or (II) is free of such group. Steric effects for example steric hindrance of a terminal alkyl group such as methyl, may affect the reactivity of the olefinic or acetylenic bond. In one embodiment, the unsaturated silane (I) or (II) is free of such sterically hindering group. Groups enhancing the stability of the radical formed during the grafting reaction, for example double bond or aromatic group conjugated with the unsaturation of the silane, are preferably present in the unsaturated silane(I) or (II). The latter groups have an activation effect with respect to the —CH═CH— or —C≡C— bond.

Preferred silanes include those of the form R″—CH═CH—X—Y—SiRₐR′₍₃₋ₐ₎ (III) or R″—C≡C—X—Y—SiRₐR′₍₃₋ₐ₎ (IV) in which X represents a chemical linkage having an electron-withdrawing effect with respect to the —CH═CH— or —C≡C— bond such as a carboxyl, carbonyl, diene, arylene or amide linkage, and Y represents a divalent organic spacer linkage comprising at least one carbon atom separating the linkage X from the Si atom.

The invention includes the polyethylene grafted with hydrolysable silane groups produced by the above process. When the unsaturated silane contains an olefinic —CH═CH— bond, the grafted polyethylene generally contains grafted moieties of the formula R″—CH(PE)-CH₂—X—Y—SiRₐR′₍₃₋ₐ₎ and/or grafted moieties of the formula R″—CH₂—CH(PE)-X—Y—SiRₐR′₍₃₋ₐ₎ wherein R represents a hydrolysable group; R′ represents a hydrocarbyl group having 1 to 6 carbon atoms; a has a value in the range 1 to 3 inclusive; X represents a chemical linkage having an electron withdrawing effect; Y represents a divalent organic spacer linkage comprising at least one carbon atom separating the linkage X from the Si atom; R″ represents hydrogen or a group of the formula —X—Y—SiRₐR′₍₃₋ₐ₎; and PE represents a polyethylene chain.

When the unsaturated silane contains an acetylenic —C≡C— bond, the grafted polyethylene generally contains grafted moieties of the formula R″—C(PE)═CH—X—Y—SiRₐR′₍₃₋ₐ₎ and/or grafted moieties of the formula R″—CH═C(PE)-X—Y—SiRₐR′₍₃₋ₐ₎PE wherein R represents a hydrolysable group; R′ represents a hydrocarbyl group having 1 to 6 carbon atoms; a has a value in the range 1 to 3 inclusive; X represents a chemical linkage having an electron withdrawing effect; Y represents a divalent organic spacer linkage comprising at least one carbon atom separating the linkage X from the Si atom; R″ represents hydrogen or a group of the formula —X—Y—SiRₐR′₍₃₋ₐ₎; and PE represents a polyethylene chain.

The invention also includes a process for crosslinking polyethylene, characterized in that grafted polyethylene produced as described above is exposed to moisture in the presence or in the absence of a silanol condensation catalyst.

The polyethylene starting material can be any polymer comprising at least 50% by weight ethylene units. Homopolyethylene is preferred, for example high density polyethylene of density 0.955 to 0.97 g/cm³, medium density polyethylene (MDPE) of density 0.935 to 0.955 g/cm³ or low density polyethylene (LDPE) of density 0.918 to 0.935 g/cm³ including ultra low density polyethylene, high pressure low density polyethylene and low pressure low density polyethylene, or microporous polyethylene. The polyethylene can for example be produced using a Ziegler-Natta catalyst, a chromium catalyst or a metallocene catalyst. For use in water pipes, the density of the polyethylene is preferably at least 0.940 g/cm³ in order that the pipes will resist hydrostatic pressure during its entire service life. For non-pipe applications, for example wire and cable insulation, lower density polyethylene resin can be used. The polyethylene can alternatively be an ethylene copolymer such as an ethylene vinyl acetate copolymer (EVA) containing for example 70 to 95% by weight ethylene units and 5 to 30% by weight vinyl acetate units or a copolymer of ethylene with up to 50% by weight of another alpha-olefin such as propylene, 1-butene, 1-hexene or 1-octene, an ethylene propylene diene terpolymer containing up to 5% by weight diene units, or an ethylene acrylic copolymer comprising at least 50% by weight ethylene with at least one acrylic polymer selected from acrylic and methacrylic acids, acrylonitrile, methacrylonitrile, and esters thereof, particularly alkyl esters having 1 to 16 carbon atoms in the alkyl group such as methyl acrylate, ethyl acrylate or butyl acrylate. The polyethylene can be chlorinated provided that at least 50% of the ethylene units are unmodified, or can be an ethylene vinyl acetate chlorine terpolymer.

For crosslinking to form crosslinked polyethylene water pipes, the polyethylene preferably has a melt flow rate (MFR 2.16 kg/190° C. according to method ISO1133) before reaction with the silane of at least 2.0 g/10 min. The polyethylene can have a monomodal or mutimodal molecular weight distribution, and/or a mixture of different polyethylenes can be used. The unsaturated silane and the compound capable of generating free radical sites in the polyethylene can be mixed with one type of polyethylene to form a masterbatch which can subsequently be mixed with a different type of polyethylene. For example microporous polyethylene is very effective in mixing with liquid additives to form a masterbatch. The polyethylene can even be mixed with a different polymer, for example another polyolefin such as polypropylene, provided that the polymers are miscible and the proportion of ethylene units in the resulting polyethylene composition is at least 50% by weight.

Each hydrolysable group R in the —SiRₐR′₍₃₋ₐ₎ group of the unsaturated silane of the formula R″—CH═CH—Z (I) or R″—C≡C—Z (II) is preferably an alkoxy group, although alternative hydrolysable groups such as acyloxy, for example acetoxy, ketoxime, for example methylethylketoxime, alkyllactato, for example ethyllactato, amino, amido, aminoxy or alkenyloxy groups can be used. Alkoxy groups R generally each have a linear or branched alkyl chain of 1 to 6 carbon atoms, and most preferably are methoxy or ethoxy groups. The value of a in the silane (I) or (II) can for example be 3, for example the silane can be a trimethoxy silane, to give the maximum number of hydrolysable and/or crosslinking sites. However each alkoxy group generates a volatile organic alcohol when it is hydrolyzed, and it may be preferred that the value of a in the silane (I) or (II) is 2 or even 1 to minimize the volatile organic material emitted during crosslinking. The group R′ if present is preferably a methyl or ethyl group.

The unsaturated silane can be partially hydrolysed and condensed into oligomers containing siloxane linkages, provided that such oligomers still contain at least one hydrolysable group bonded to Si per unsaturated silane monomer unit, so that the grafted polyethylene has sufficient reactivity towards itself or towards polar surfaces and materials. If the grafted polyethylene is to be crosslinked in a second stage, it is usually preferred that hydrolysis and condensation of the silane before grafting should be minimized.

In the unsaturated silane of the formula R″—CH═CH—X—Y—SiRₐR′₍₃₋ₐ₎ (III) or R″—C≡C—X—Y—SiRₐR!₍₃₋ₐ₎ (IV), the electron-withdrawing linkage X is preferably a carboxyl linkage. Preferred silanes thus have the formula R″—CH═CH—C(═O)O—Y—SiRₐR′₍₃₋ₐ₎ (V). The spacer linkage Y can in general be a divalent organic group comprising at least one carbon atom, for example an alkylene group such as methylene, ethylene or propylene, or an arylene group, or a polyether chain, e.g., polyethylene glycol or polypropylene glycol. When the group R″ represents hydrogen and Y represents an alkylene group, the moiety R″—CH═CH—C(═O)O—Y— in the unsaturated silane (I) is an acryloxyalkyl group. We have found that acryloxyalkylsilanes graft to polyethylene much more readily than vinylsilanes or methacryloxyalkylsilanes. Examples of preferred acryloxyalkylsilanes are γ-acryloxypropyltrimethoxysilane, acryloxymethyltrimethoxysilane, acryloxymethylmethyldimethoxysilane, acryloxymethyldimethylmethoxysilane, γ-acryloxypropylmethyldimethoxysilane and γ-acryloxypropyldimethylmethoxysilane. γ-Acryloxypropyltrimethoxysilane can be prepared from allyl acrylate and trimethoxysilane by the process described in U.S. Pat. No. 3,179,612. γ-Acryloxypropylmethyldimethoxysilane and γ-acryloxypropyldimethylmethoxysilane can similarly be prepared from allyl acrylate and methyldimethoxysilane or dimethylmethoxysilane respectively. Acryloxymethyltrimethoxysilane can be prepared from acrylic acid and chloromethyltrimethoxysilane by the process described in U.S. Pat. No. 3,179,612.

The group R″ in the silane of the formula R″—CH═CH—X—Y—SiRₐR′₍₃₋ₐ₎ (III) or R″—C≡C—X—Y—SiRₐR′₍₃₋ₐ₎ (IV) can alternatively be an alkenyl group, for example R″ can be a propenyl group, X a C(═O)O group and Y an alkylene group, with the silane being an alkoxysilylalkyl ester of sorbic acid.

The group R″ in the unsaturated silane (I) or (II) can alternatively be an electron-withdrawing group of the formula —X—Y—SiRₐR′₍₃₋ₐ₎, for example an electron-withdrawing group where the linkage —X— is a carboxyl linkage. The unsaturated silane can thus be of the form RₐR′₍₃₋ₐ₎Si—Y—O(O═)C—CH═CH—C(═O)O—Y—Si RₐR′₍₃₋ₐ₎ (VI) that is the unsaturated silane (I) can comprise a bis(trialkoxysilylalkyl)fumarate (trans-isomer) and/or a bis(trialkoxysilylalkyl)maleate (cis-isomer).

Examples are:

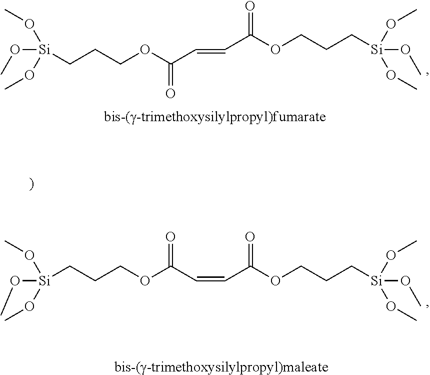

Their preparation is described in U.S. Pat. No. 3,179,612. Alternatively the electron-withdrawing group in (III) or (IV) can be of the form —XH or —XR*, where R* is an alkyl group. The unsaturated silane can be a mono(trialkoxysilylalkyl)fumarate and/or a mono(trialkoxysilylalkyl)maleate, or can be a trialkoxysilylalkyl ester of an alkyl monofumarate and/or an alkyl monomaleate.

The unsaturated silane can also be of the form:

RₐR′₍₃₋ₐ₎Si—Y—O(O═)C—C≡C—C(═O)O—Y—Si RₐR′₍₃₋ₐ₎ (VII).

Example is:

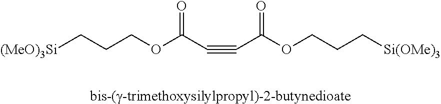

Alternatively, the bis-silanes (VI) or (VII) can be asymmetrical e.g. with Y, R and R′ being different on each side of the molecule.

In general, all unsaturated silanes which are silylalkyl esters of an unsaturated acid can be prepared from the unsaturated acid, for example acrylic, maleic, fumaric, sorbic or cinnamic acid, propynoic or butyne-dioic acid, by reaction of the corresponding carboxylate salt with the corresponding chloroalkylalkoxysilane. In a first step, the alkali salt of the carboxylic acid is formed either by reaction of the carboxylic acid with alkali alkoxide in alcohol, as described e.g. in U.S. Pat. No. 4,946,977, or by reaction of the carboxylic acid with aqueous base and subsequent removal of the water via azeotropic distillation, as described e.g. in WO-2005/103061. A trialkyl ammonium salt of the carboxylic acid can be formed by direct reaction of the free carboxylic acid with trialkyl amine, preferentially tributyl amine or triethyl amine as described in U.S. Pat. No. 3,258,477 or U.S. Pat. No. 3,179,612. In a second step the carboxylic acid salt is then reacted via nucleophilic substitution reaction with the chloroalkylalkoxysilane under formation of the alkali chloride or trialkylammonium chloride as a by-product. This reaction can be performed with the chloroalkylalkoxysilane under neat condition or in solvents such as benzene, toluene, xylene, or a similar aromatic solvent, as well as methanol, ethanol, or another alcohol-type solvent. It is preferably to have a reaction temperature within the range of 30 to 180° C., preferably within the range of 100 to 160° C. In order to speed up this replacement reaction, phase transfer catalysts of various kinds can be used. Preferable phase transfer catalysts are the following: tetrabutylammonium bromide (TBAB), trioctylmethylammonium chloride, Aliquat® 336 (Cognis GmbH) or similar quaternary ammonium salts (as e.g. used in U.S. Pat. No. 4,946,977), tributylphosphonium chloride (as e.g. used in U.S. Pat. No. 6,841,694), guanidinium salts (as e.g. used in EP0900801) or cyclic unsaturated amines as 1,8-diazabicyclo[5.4.0]undeca-7-ene (DBU, as e.g. used in WO2005/103061). If necessary, the following polymerization inhibitors can be used throughout preparation and/or purification steps: hydroquinones, phenol compounds such as methoxyphenol and 2,6-di-t-butyl 4-methylphenol, phenothiazine, p-nitrosophenol, amine-type compounds such as e.g. N,N′-diphenyl-p-phenylenediamine or sulfur containing compounds as described in but not limited to the patents cited above.

Blends of unsaturated silanes can be used, for example a blend of γ-acryloxypropyltrimethoxysilane with acryloxymethyltrimethoxysilane or a blend of γ-acryloxypropyltrimethoxysilane and/or acryloxymethyltrimethoxysilane with an unsaturated silane containing no electron withdrawing groups such as vinyltrimethoxysilane or with an acryloxysilane containing 1 or 2Si-alkoxy groups such as acryloxymethylmethyldimethoxysilane, acryloxymethyldimethylmethoxysilane, γ-acryloxypropylmethyldimethoxysilane or γ-acryloxypropyldimethylmethoxysilane.

The unsaturated silane (I) or (II) should be present in an amount sufficient to graft silane groups to polyethylene. In some embodiments, other silane compounds are added for example for adhesion promotion but it is preferred that the major part of silane compound present during the process is the unsaturated silane (I) or (II) so as to obtain efficient grafting.

The grafting process takes place when means or compound are provided to generate free radical sites in the polyethylene. Means can be for example an electron beam or high shear. Preferably, a compound capable of generating free radical sites in the polyethylene is present. This compound is preferably an organic peroxide, although other free radical initiators such as azo compounds can be used. Examples of preferred peroxides include 2,5-dimethyl-2,5-di-(tert-butylperoxy)hexane, di-tert-butyl peroxide, 3,6,9-triethyl-3,6,9-trimethyl-1,4,7-triperoxonane, tert-amylperoxy-2-ethylhexyl carbonate, tert-butylperoxy-3,5,5-trimethylhexanoate, 2,2-di(tert-butylperoxy)butane, tert-butylperoxy isopropyl carbonate, tert-butylperoxy-2-ethylhexyl carbonate, butyl 4,4-di(tert-buylperoxy)valerate, di-tert-amyl peroxide, benzoyl peroxide, dichlorobenzoyl peroxide, dicumyl peroxide, 2,5-dimethyl-2,5-di(peroxybenzoate)hexyne-3,1,3-bis(t-butylperoxyisopropyl)benzene, lauroyl peroxide, tert-butyl peracetate, tert-butyl perbenzoate and 2,5-dimethyl-2,5-di-(tert-butylperoxy)hexyne-3. For grafting and crosslinking polyethylene for use in drinking water pipes, the peroxide preferably does not contain any aromatic ring in order to prevent negative impact of the degradation product on organoleptic properties of the water. Examples of azo compounds are azobisiosobutyronitrile and dimethylazodiisobutyrate. The above radical initiators can be used alone or in combination of at least two of them. The peroxide or other compound capable of generating free radical sites in the polyethylene is preferably available in a liquid form at ambient temperature in order that a homogeneous blend with the silane can be prepared before injection into the polyethylene in the compounding apparatus.

The temperature at which the polyethylene and the unsaturated silane (I) or (II) are reacted in the presence of the compound capable of generating free radical sites in the polyethylene is generally above 140° C. and is sufficiently high to melt the polyethylene and to decompose the free radical initiator. A temperature in the range 170° C. to 230° C. is usually preferred. The peroxide or other compound capable of generating free radical sites in the polyethylene preferably has a decomposition temperature in a range between 120-220° C., preferably between 160-190° C.

The amount of unsaturated silane (I) or (II) present during the grafting reaction is generally at least 0.2% by weight based on the total composition and can be up to 20% or more. By total composition we mean the starting composition containing all ingredients, including polymer, silane, filler, catalyst etc which are brought together to form the reacting mixture. Preferably the unsaturated silane (I) or (II) is present at 0.5 to 15% by weight based on the total composition during the grafting reaction. Most preferably the unsaturated silane (I) or (II) is present at 1.0 to 10% by weight based on the total composition during the grafting reaction.

The compound capable of generating free radical sites in the polyethylene is generally present in an amount of at least 0.01% by weight based on the total composition during the grafting reaction and can be present in an amount of up to 1 or 2%. Organic peroxide, for example, is preferably present at 0.01 to 0.5% by weight based on the total composition during the grafting reaction.

The grafting reaction between the polyethylene and the unsaturated silane (I) or (II) can be carried out as a batch process or as a continuous process using any suitable apparatus. The polyethylene can for example be added in pellet or powder form or a mixture thereof. The polyethylene is preferably subjected to mechanical working while it is heated. A batch process can for example be carried out in an internal mixer such as a Brabender Plastograph (Trade Mark) 350S mixer equipped with roller blades, or a Banbury mixer. A roll mill can be used for either batch or continuous processing. In a batch process, the polyethylene, the unsaturated silane and the compound capable of generating free radical sites in the polyethylene are generally mixed together at above 140° C. for at least 1 minute and can be mixed for up to 30 minutes, although the time of mixing at high temperature is generally 3 to 15 minutes. The reaction mixture can be held at a temperature above 140° C. for a further period of for example 1 to 20 minutes after mixing to allow the grafting reaction to continue.

Continuous processing is generally preferred, and the preferred vessel is an extruder adapted to mechanically work, that is to knead or compound, the materials passing through it, for example a twin screw extruder. One example of a suitable extruder is that sold under the trade mark ‘Ko-Kneader’. The extruder preferably includes a vacuum port shortly before the extrusion die to remove any unreacted silane. The residence time of the polyethylene, the unsaturated silane and the compound capable of generating free radical sites in the polyethylene together at above 140° C. in the extruder or other continuous reactor is generally at least 0.5 minutes and preferably at least 1 minute and can be up to 15 minutes. More preferably the residence time is 1.5 to 5 minutes. All or part of the polyethylene may be premixed with the unsaturated silane and/or the compound capable of generating free radical sites in the polyethylene before being fed to the extruder, but such premixing is generally at below 140° C., for example at ambient temperature.

The grafted polyethylene is usually crosslinked by exposure to moisture. In one embodiment, such crosslinking is made in the presence of a silanol condensation catalyst. Any suitable condensation catalyst may be utilized. These include protic acids, Lewis acids, organic and inorganic bases, transition metal compounds, metal salts and organometallic complexes.

Preferred catalysts include organic tin compounds, particularly organotin salts and especially diorganotin dicarboxylate compounds such as dibutyltin dilaurate, dioctyltin dilaurate, dimethyltin dibutyrate, dibutyltin dimethoxide, dibutyltin diacetate, dimethyltin bisneodecanoate, dibutyltin dibenzoate, dimethyltin dineodeconoate or dibutyltin dioctoate. Alternative organic tin catalysts include triethyltin tartrate, stannous octoate, tin oleate, tin naphthate, butyltintri-2-ethylhexoate, tin butyrate, carbomethoxyphenyl tin trisuberate and isobutyltin triceroate. Organic compounds, particularly carboxylates, of other metals such as lead, antimony, iron, cadmium, barium, manganese, zinc, chromium, cobalt, nickel, aluminium, gallium or germanium can alternatively be used.

The condensation catalyst can alternatively be a compound of a transition metal selected from titanium, zirconium and hafnium, for example titanium alkoxides, otherwise known as titanate esters of the general formula Ti[OR⁵]₄ and/or zirconate esters Zr[OR⁵]₄ where each R⁵ may be the same or different and represents a monovalent, primary, secondary or tertiary aliphatic hydrocarbon group which may be linear or branched containing from 1 to 10 carbon atoms. Preferred examples of R⁵ include isopropyl, tertiary butyl and a branched secondary alkyl group such as 2,4-dimethyl-3-pentyl. Alternatively, the titanate may be chelated with any suitable chelating agent such as acetylacetone or methyl or ethyl acetoacetate, for example diisopropyl bis(acetylacetonyl)titanate or diisopropyl bis(ethylacetoacetyl)titanate.

The condensation catalyst can alternatively be a protonic acid catalyst or a Lewis acid catalyst. Examples of suitable protonic acid catalysts include carboxylic acids such as acetic acid and sulphonic acids, particularly aryl sulphonic acids such as dodecylbenzenesulphonic acid. A “Lewis acid” is any substance that will take up an electron pair to form a covalent bond, for example, boron trifluoride, boron trifluoride monoethylamine complex, boron trifluoride methanol complex, FeCl₃, AlCl₃, ZnCl₂, ZnBr₂ or catalysts of formula MR⁴_{f}X_{g} where M is B, Al, Ga, In or Tl, each R⁴ is independently the same or different and represents a monovalent aromatic hydrocarbon radical having from 6 to 14 carbon atoms, such monovalent aromatic hydrocarbon radicals preferably having at least one electron-withdrawing element or group such as —CF₃, —NO₂ or —CN, or substituted with at least two halogen atoms; X is a halogen atom; f is 1, 2, or 3; and g is 0, 1 or 2; with the proviso that f+g=3. One example of such a catalyst is B(C₆F₅)₃.

An example of a base catalyst is an amine or a quaternary ammonium compound such as tetramethylammonium hydroxide, or an aminosilane. Amine catalysts such as laurylamine can be used alone or can be used in conjunction with another catalyst such as a tin carboxylate or organotin carboxylate.

The silanol condensation catalyst is preferably incorporated into the grafted polyethylene and the grafted polyethylene is then shaped into an article and subsequently crosslinked by moisture. The catalyst can be mixed with the polyethylene before, during or after the grafting reaction. Mixing of the catalyst after grafting is preferred.

In one preferred procedure, the polyethylene, the unsaturated silane and the compound capable of generating free radical sites in the polyethylene are mixed together at above 140° C. in a twin screw extruder to graft the silane to the polyethylene, and the resulting grafted polyethylene is mixed with the silanol condensation catalyst in a subsequent mixing step. Mixing with the catalyst can for example be carried continuously in an extruder, which can be an extruder adapted to knead or compound the materials passing through it such as a twin screw extruder as described above or can be a more simple extruder such as a single screw extruder. Since the grafted polyethylene is heated in such a second extruder to a temperature above 140° C. and above the melting point of the polyethylene, the grafting reaction may continue in the second extruder.

In an alternative preferred procedure, the silanol condensation catalyst can be premixed with part of the polyethylene and the unsaturated silane (I), (II), (Ill) or (IV) can be premixed with a different portion of the polyethylene, and the two premixes can be contacted, optionally with further polyethylene, in the mixer or extruder used to carry out the grafting reaction. Since most unsaturated silanes and the preferred condensation catalysts such as diorganotin dicarboxylates are liquids, it may be preferred to absorb each of them separately on microporous polyethylene before mixing with the bulk of the polyethylene in an extruder.

Whatever the mixing procedure used for adding the catalyst to the grafted polyethylene, care must be taken to avoid exposure of the silane and catalyst together to moisture, or of the silane-grafted polyethylene compound to moisture before its final shape into the desired article.

The silane condensation catalyst is typically used at 0.005 to 1.0% by weight based on the total composition. For example a diorganotin dicarboxylate is preferably used at 0.01 to 0.1% by weight based on the total composition.

Alternatively or additionally to incorporation of the silanol condensation catalyst in the grafted polyethylene, the silanol condensation catalyst can be dissolved in the water used to crosslink the grafted polyethylene. For example a thermoformed part, shaped from grafted polyethylene by moulding or extrusion, can be cured under water containing dissolved diorganotin carboxylate or a carboxylic acid catalyst such as acetic acid.

In other preferred embodiments, crosslinking is made in the absence of silanol condensation catalyst. This is advantageous as it permits to decrease the number of reactants needed, cost and risk of pollution linked to the use of silanol condensation catalyst especially those based on tin.

U.S. Pat. No. 7,015,297 provide alkoxysilane-terminated polymer systems which on curing not only crosslink, but also bring about chain extension of the polymers. It is said that by incorporating dialkoxy alpha-silanes, the reactivity of such compositions is also sufficiently high that it is possible to produce compositions without the use of relatively large amounts of catalysts which generally contain tin. US20050119436 reports that EP 372 561 A describes the preparation of a silane-crosslinkable polyether which has to be stored with exclusion of moisture, since it vulcanizes with or without silane condensation catalysts. We have observed that alpha-acryloxymethyl silanes (aATM) grafted to polyethylene enables to crosslink the compounded material at the same speed independently of the absence or presence of condensation catalyst. On the other hand, with other silanes, it was observed that crosslinking will occur to a certain extent, but the speed will be inferior in absence of condensation catalyst against its presence.

For many uses the crosslinked polyethylene preferably contains at least one antioxidant. Examples of suitable antioxidants include tris(2,4-di-tert-butylphenyl)phosphite sold commercially under the trade mark Ciba Irgafos0168, tetrakis [methylene-3-(3,5-di-tert-butyl-4-hydroxyphenyl-propionate)]methane processing stabilizer sold commercially under the trade mark Ciba Irganox®1010 and 1.3.5-trimethyl-2.4.6-tris(3.5-di-tert-butyl-4-hydroxy benzyl)benzene sold commercially under the trade mark Ciba Irganox®1330. It may also be desired that the crosslinked polyethylene contains a hindered amine light stabiliser such as a 4-substituted-1,2,2,6,6-pentamethylpiperidine, for example those sold under the trade marks Tinuvin 770, Tinuvin 622, Uvasil 299, Chimassorb 944 and Chimassorb 119. The antioxidant and/or hindered amine light stabiliser can conveniently be incorporated in the polyethylene either with the unsaturated silane and the organic peroxide during the grafting reaction or with the silanol condensation catalyst if this is added to the grafted polyethylene in a separate subsequent step. The total concentration of antioxidants and light stabilisers in the crosslinked polyethylene is typically in the range 0.02 to 0.20% by weight based on the total composition.

The grafted polyethylene containing silanol condensation catalyst and antioxidant and/or hindered amine light stabiliser can for example be shaped into pipes by extrusion. Such pipes are used particularly for transporting water, for example drinking water, water for underfloor heating or water for conventional heating systems.

The crosslinked polyolefins of the invention can be used in a wide variety of products. The grafted polyolefin can be blow moulded or rotomoulded to form bottles, cans or other liquid containers, liquid feeding parts, air ducting parts, tanks, including fuel tanks, corrugated bellows, covers, cases, tubes, pipes, pipe connectors or transport trunks. The grafted polyolefin can be extruded to form pipes, corrugated pipes, sheets, fibers, plates, coatings, film, including shrink wrap film, profiles, flooring, tubes, conduits or sleeves, or extruded onto wire or cable as an electrical insulation layer. The grafted polyolefin can be injection moulded or press moulded to form tube and pipe connectors, packaging, gaskets and panels. The grafted polyolefin can also be foamed or thermoformed. In each case the shaped article can be crosslinked by exposure to moisture in the presence or absence of a silanol condensation catalyst.

Crosslinked polyolefin articles produced according to the invention have improved mechanical strength, melt strength, heat resistance, chemical and oil resistance, creep resistance and/or environmental stress cracking resistance compared to articles formed from the same polyolefin without grafting or crosslinking.

The grafted polyethylene of the present invention can also be used for either improving the compatibility of polyethylene with fillers commonly used for reinforcing composites materials, or increasing the surface energy of polyethylene for further improve the coupling or adhesion of polyethylene based materials with high surface energy polymers typically used in inks, paints and coatings.

In a preferred embodiment, the unsaturated silane (I) or (II) is deposited on a filler before being reacted with polyethylene. This permits an easy handling of the unsaturated silane and a decrease of the number of steps needed to obtain the filled polymer.

The improvement in grafting of the silane to the polyethylene leads to more efficient crosslinking. We have found that the silane grafted polyethylene produced according to the invention can, when molded into a 2 mm thickness plate or extruded as a pipe of 16 mm internal diameter and 2 mm wall thickness, be cured to a 65% gel content with a gain up to 30% in time necessary for curing at 95° C. underwater or under ambient room conditions in comparison to existing commercially available vinylsilane-grafted polyethylene such as that sold under the trademark Sioplas®E. A 65% gel content corresponds to effective crosslinking as shown by a sharp increase in heat and chemical resistance of the polyethylene and in mechanical strength. The more efficient crosslinking also leads to a more efficient and rapid reduction in the Total Organic Carbon (TOC) content and Threshold Odor Number (TON) detectable in water that circulated into a 16×2 mm pipe section. This is very important for pipes carrying drinking water. Known crosslinked polyethylene pipes require flushing with water for four to seven days to achieve a TOC below 2.5 mg/m² day, whereas a crosslinked polyethylene pipe according to the present invention may achieve this in approximately one day.

It was observed that adding silanol rich additive to the composition permits to accelerate the rate of crosslinking rate of silane-crosslinked polyethylene.

Therefore, in a preferred embodiment, a silanol-containing silicone compound is added after the grafting reaction.

Preferably, the silanol-containing compound is present at 1% to 10% by weight based on the total composition obtained after the grafting reaction.

The silanol-containing compound is preferably added together with the silanol condensation catalyst, after grafting polyethylene with silane.

This silanol-containing silicone compound can be a diol terminated siloxane compound or a silanol functional silicone resin.

A diol terminated siloxane compound may comprise a small number (e.g., 15 on average) of R62SiO moeties where R6 is alkyl for example methyl for PDMS siloxane.

Silanol functional silicone resins are known in the art and commercially available. Silanol functional silicone resins can comprise combinations of M, D, T, and Q units, such as DT, MDT, DTQ, MQ, MDQ, MDTQ, or MTQ resins; alternatively T (silsesquioxane) resins or DT resins. For purposes of this application, “D unit” means a unit of the formula R⁷₂SiO_{2/2}, “M unit” means a unit of the formula R⁷₃SiO_{1/2}, “Q unit” means a unit of the formula SiO_{4/2}, and “T unit” means a unit of the formula R₇SiO_{3/2}; where each R⁷ is independently an organic group or a silanol group.

DT resins are exemplified by resins comprising the formula:

(R⁸R⁹SiO_{2/2})ₕ(R¹⁰SiO_{3/2})ᵢ.

Each instance of R⁸, R⁹ and R¹⁰ may be the same or different. R⁸, R⁹ and R¹⁰ may be different within each unit. Each R⁸, R⁹ and R¹⁰ independently represent a hydroxyl group or an organic group, such as a hydrocarbon group or alkoxy group. Hydrocarbon groups can be saturated or unsaturated. Hydrocarbon groups can be branched, unbranched, cyclic, or combinations thereof. Hydrocarbon groups can have 1 to 40 carbon atoms, alternatively 1 to 30 carbon atoms, alternatively 1 to 20 carbon atoms, alternatively 1 to 10 carbon atoms, and alternatively 1 to 6 carbon atoms. The hydrocarbon groups may include alkyl groups such as methyl, ethyl, n-propyl, isopropyl, n-butyl, and t-butyl; alternatively methyl or ethyl; and alternatively methyl. The hydrocarbon groups may include aromatic groups such as phenyl, tolyl, xylyl, benzyl, and phenylethyl; and alternatively phenyl. Unsaturated hydrocarbon groups include alkenyl such as vinyl, allyl, butenyl, and hexenyl.

In the formula above, h may range from 1 to 200, alternatively 1 to 100, alternatively 1 to 50, alternatively 1 to 37, and alternatively 1 to 25. In the formula above, i may range from 1 to 100, alternatively 1 to 75, alternatively 1 to 50, alternatively 1 to 37, and alternatively 1 to 25.

Alternatively, the DT resin may have the formula: (R⁸₂SiO_{2/2})ₕ(R⁹₂SiO_{2/2})ᵢ (R⁸SiO_{3/2})ₕ(R⁹SiO_{3/2})ᵢ, where R⁸, R⁹, h, and i are as described above. Alternatively, in this formula, each R⁸ may be an alkyl group and each R⁹ may be an aromatic group. MQ resins are exemplified by resins of the formula: (R⁸R⁹R³SiO_{1/2})ⱼ(SiO_{4/2})ₖ, where R⁸, R⁹ and R¹⁰ are as described above, j is 1 to 100, and k is 1 to 100, and the average ratio of j to k is 0.65 to 1.9.

The silanol functional silicone resin selected will depend on various factors including the other ingredients selected for the composition, e.g., including catalyst type and amount, compatibility with the polyethylene polymer, process conditions during compounding, packaging, and application.

Preferably silanol-terminated MQ resins are used in a solid form and for their good compatibility with the polyethylene polymer. More preferably, the MQ solid resin contains from 2 to 6% by weight of silanol groups, for example ca 4% by weight.

The invention is illustrated by the following Examples.

### Raw Materials Description

### Polymers and Oil

High-density-polyethylene (HDPE) pellets were Basell Lupolen®5031LQ449K with a density of 0.955 g/cm³ (method ISO1183A), MFR(2.16 kg/190° C.) 4.0 g/10 min (method ISO1133), hardness 62 shore D (method ISO868) and a Vicat softening point (49N) of 70° C. (method ISO306B). Medium-density-polyethylene (MDPE) pellets were Innovene® A4040 with a density of 0.944 g/cm³ (method ISO1183A), MFR(2.16kg/190° C.) 3.5 g/10 min (method ISO1133), and a Vicat softening point (1 kg) of 123° C. (method ISO306B).

Microporous polyethylene pellets Membrana Accurel®XP200 was used for adsorbing liquid ingredients. Characteristics of Accurel®XP200 are MFR(2.16 kg/190° C.) 1.8 g/10 min (method ISO1133), and melting temperature (DSC) 119° C.

Naphthenic processing oil was Nyflex® 222B from Nynas with a viscosity 104 cSt (40° C., method ASTM D445) and specific gravity 0.892 g/cm³ (method ASTM D4052).

Multibase® MB50-314 processing aid was ultra-high molecular weight functionalized siloxane polymer dispersed in high density polyethylene and used for improving processing and flow of the silane-grafted-polyethylene during grafting and extrusion steps in the twin screw extruder.

### Peroxides

2,5-dimethyl-2,5-di-(tert-butylperoxy)hexane (DHBP) peroxide (purity 91.2%) was Arkema Luperox®101 and was used in its pure liquid form. Di-tert-butyl peroxide (purity 99%) was Akzo-Nobel Trigonox®B and was used in its pure liquid form.

3,6,9-Triethyl-3,6,9-trimethyl-1,4,7-triperoxonane peroxide (purity 41% in solution in isoparaffinic hydrocarbons) was Akzo-Nobel Trigonox®301.

### Silanes

Vinyltrimethoxysilane (VTM) was Dow Corning® Z6300; γ-methacryloxypropyltrimethoxysilane (γ-MTM) silane was Dow Corning® Z6030; γ-Acryloxypropyltrimethoxysilane (γ-ATM) was prepared from allyl acrylate and trimethoxysilane by the process described in U.S. Pat. No. 3,179,612. α-Acryloxymethyltrimethoxysilane (α-ATM) was prepared from acrylic acid and chloromethyltrimethoxysilane by the procedure described in Example 5 of U.S. Pat. No. 3,258,477; bis-(γ-trimethoxysilylpropyl)fumarate silane (BGF), bis-(γ-trimethoxysilylpropyl)maleate silane (BGM) and mixtures of them were prepared as described in U.S. Pat. No. 3,179,612. The direct reaction product comprised 43% BGM and 57% BGF. This mixture was separated to yield a pure BGF product and a mixture comprising 86% BGM and 14% BGF; α-acryloxymethyldimethylmethoxysilane (α-AMM) was prepared from acrylic acid and dimethylchloromethylmethoxysilane by the procedure described in Example 5 of U.S. Pat. No. 3,258,477.

### Catalysts

Condensation catalyst used were:
1% acetic acid diluted into water for curing molded or injected specimens underwater;
Dioctyltindilaurate (DOTDL) supplied by ABCR® (ref. AB106609) diluted into Naphthenic processing oil Nyflex® 222B sold by Nynas with a viscosity of 104 cSt (40° C., method ASTM D445) and specific gravity 0.892 g/cm3 (method ASTM D4052) for compounding into the composite material

### Antioxidants

Tris-(2,4-di-tert-butylphenyl)phosphite was Ciba Irgafose168. Tetrakis[methylene-3-(3,5-di-tert-butyl-4-hydroxyphenyl-propionate)]methane processing stabilizer was Ciba Irganox®1010. 3,3′,3′,5′,5′-hexa-tert-butyl-a,a′,a′-(mesitylene-2,4,6-triyl)tri-p-cresol was Ciba Irganox®1330. Octadecyl-3-(3,5-di-tert.butyl-4-hydroxyphenyl)-propionate was Ciba Irganox®1076.

### EXAMPLE 1

4.3% by weight Accurel®XP200 porous polyethylene pellets were tumbled with 3% by weight γ-acryloxypropyltrimethoxysilane and 0.1% by weight Luperox®101 until the liquid reagents were absorbed by the polyethylene to form a silane masterbatch. Separately, 4.3% by weight Accurel®XP200 porous polyethylene pellets were tumbled with 0.03% by weight dioctyltin dilaurate diluted into 2.1% by weight Nyflex®222B naphthenic oil, 0.10% by weight Irgafos®168 phosphine antioxidant and 0.05% by weight Irganox®1010 phenolic antioxidant to form a catalyst/antioxidant masterbatch.

86% by weight Lupolen®5031LQ449K high density polyethylene (HDPE) pellets were loaded in a Brabender® Plastograph 350S mixer equipped with roller blades, in which compounding was carried out. Rotation speed was 100 rpm, and the initial temperature of the chamber was set at 200° C. Torque and temperature of the melt were monitored for controlling the reactive processing of the ingredients. The HDPE was mixed for 2 minutes, then the silane masterbatch was added and mixed for 2 minutes to start the grafting reaction. The catalyst/antioxidant masterbatch was then added and mixed for a further 4 minutes during which grafting continued, with substantially no crosslinking in the absence of water. The melt was then dropped from the mixer and cast in an Agila®PE30 press into 2 mm thick plates at 200° C. for 5 minutes before cooling down to ambient temperature for 2 minutes.

Samples of the 2 mm sheet were cured underwater at 95° C. for different periods of time from 1 to 24 hours, in order to generate crosslinked polyethylene samples with different degrees of crosslinking.

### EXAMPLE 2

Example 1 was repeated with the amount of γ-acryloxypropyltrimethoxysilane reduced from 3% by weight down to 1% by weight.

### COMPARATIVE EXAMPLES C1 AND C2

Examples 1 and 2 were repeated replacing the γ-acryloxypropyltrimethoxysilane by an equimolar amount of vinyltrimethoxysilane in each Comparative Example.

For each Example, the torque increase during compounding, the grafting yield, the gel content of the crosslinked polyethylene after 24 hours curing, and the elastic shear modulus G′ of the crosslinked polyethylene initially after sheet moulding and after 24 hours curing were measured. These are recorded in Table 1.

The processing torque is the measure of the torque in Newton*meter (N.m) applied by the motor of the Plastograph 350S mixer to maintain the mixing speed of 100 rpm.

Grafting yields were calculated by estimating the amount of silicon in the crosslinked polyethylene specimens from gravimetric determination after treating the material with sulfuric acid and hydrofluoric acid at high temperature according to the dissolution method described by e.g. F. J. Langmyhr et al. in Anal. Chim. Acta, 1968, 43, 397.

Gel content was determined using method ISO 10147 “Pipes and fittings made of crosslinked polyethylene (PE-X)—Estimation of the degree of crosslinking by determination of the gel content”. The principle of the test consists in measuring the mass of a test piece taken from a molded part before and after immersion of the test piece in a solvent e.g. 8 hours in refluxing xylene. The degree of crosslinking is expressed as the percentage by mass of the insoluble material.

Elastic shear modulus (G′) measurements were carried out on an Advanced Polymer Analyzer APA2000®. 3.5 g specimens were analyzed above their melting point, at temperature of 180° C. Elastic shear modulus (G′) was recorded upon strain sweep under constant oscillating conditions (0.5 Hz). Recording the elastic shear modulus (G′), viscous shear modulus (G″), and TanD on a range of strain from 1 to 100% takes approximately 5 minutes. From the various plots of G′ as a function of percentage strain, the values at 12% strain were all in the linear viscoelastic region. The G′@12% strain value was therefore selected in order to follow the increase in elastic shear modulus as a function of time curing of the specimens described in the Examples.

TABLE 1

| | | | | | | | | | G′ @ |
|---|---|---|---|---|---|---|---|---|---|
| | | | | | | Gel | G′ @ | G′ @ | 12% strain; |
| | | Silane | Silane | Torque | Grafting | Content | 12% strain; | 12% strain; | Increase |
| | | conc. | conc. | Increase | Yield | 24 hrs | initial | 24 hrs | 24 hrs vs. |
| Example | Silane | (wt. %) | (mole %) | (N · m) | (%) | (%) | (kPa) | (kPa) | initial (%) |
| 1 | γ-ATM | 3.0 | 0.013 | 62 | 96 | 68 | 64 | 290 | 353% |
| 2 | γ-ATM | 1.0 | 0.004 | 20 | 96 | 55 | 20 | 94 | 370% |
| C1 | VTM | 1.9 | 0.013 | 30 | 81 | 65 | 89 | 250 | 181% |
| C2 | VTM | 0.6 | 0.004 | 10 | 83 | 45 | 31 | 75 | 142% |

From results shown in Table 1, it can be observed that γ-acryloxypropyltrimethoxysilane (γ-ATM) is causing larger torque increases and grafting yield than the equivalent reference compositions made with vinyltrimethoxysilane (VTM). Although the torque increase during the compounding stage in the roller blade mixer was proportional to the concentration of silane used, the grafting yield remains close to 80% for both VTM-grafted HDPE specimens, and significantly higher for both γ-ATM-grafted HDPE specimens since grafting yield was reaching values close to 100%.

The comparison of elastic shear modulus, G′@12% strain, before and after the curing cycle of 24 hours underwater at 95° C., clearly illustrates the benefit of γ-ATM against VTM for accelerating the rate of crosslinking of corresponding PEX material.

The comparison of gel content illustrates the benefit of γ-ATM against VTM for obtaining higher gel content values in the corresponding PEX material.

### EXAMPLES 3 TO 12 AND COMPARATIVE EXAMPLES C3 AND C4

Following the procedure of Example 1, 2 mm thickness sheets of polyethylene grafted with the silanes listed in Table 2 at the concentrations shown in Table 2 were prepared. No silanol condensation catalyst was mixed into the antioxidant masterbatch or added to the polyethylene. The grafted polyethylene sheet samples were crosslinked by immersion in 1% aqueous acetic acid at 95° C. for 3 or 24 hours; the acetic acid acted as catalyst of the crosslinking reaction. Torque increase, grafting yield, gel content and elastic shear modulus G′ were measured as described above and are recorded in Table 2.

Samples of the grafted polyethylene sheets produced in many of the Examples were also cured at temperatures of 30° C. and 55° C. The activation energy of the crosslinking reaction, reported to the number of moles of trimethoxysilyl-groups present in each Examples, was calculated from Arrhenius plots on G′@12% strain measurements made as a function of time underwater at temperatures of 30° C., 55° C. and 95° C. and is recorded in Table 2 for these Examples.

TABLE 2

| | | | | | | | | | | G′ @ | | Activation |
|---|---|---|---|---|---|---|---|---|---|---|---|---|
| | | | | | | | | G′ @ | G′ @ | 12% | G′ @ | Energy |
| | | | | | | Gel | Gel | 12% | 12% | strain; | 12% | Of |
| | | Silane | Silane | Torque | Grafting | content; | content; | strain; | strain; | Increase | strain; | cross- |
| Exam- | | conc. | conc. | increase | yield | Initial | 24 hrs | Initial | 3 hrs | 3 hrs vs. | 24 hrs | linking |
| ple | Silane | (wt %) | (mole %) | (N · m) | (%) | (%) | (%) | (kPa) | (kPa) | initial (%) | (kPa) | (kJ/mole) |
| C3 | VTM | 1.9 | 0.013 | 30 | 85 | 20 | 65 | 29 | 43 | 48% | 210 | 81 |
| C4 | γ-MTM | 2.6 | 0.010 | 0 | 78 | 1 | 39 | 5 | 7 | 40% | 30 | — |
| 3 | γ-ATM | 2.4 | 0.010 | 56 | 100 | 28 | 65 | 25 | 60 | 140% | 170 | 29 |
| 4 | γ-ATM | 3.0 | 0.013 | 60 | 100 | 32 | 65 | 28 | 60 | 114% | 160 | — |
| 5 | α-ATM | 1.3 | 0.006 | 30 | 100 | 27 | 48 | 15 | 53 | 253% | 110 | — |
| 6 | α-ATM | 2.2 | 0.011 | 60 | 95 | 28 | 61 | 40 | 88 | 120% | 160 | 27 |
| 7 | α-ATM | 2.6 | 0.013 | 95 | 100 | 30 | 65 | 41 | 101 | 146% | 200 | — |
| 8 | γ-ATM | 1.5 | 0.006 | 70 | 90 | 36 | 53 | 28 | 83 | 196% | 130 | — |
| | α-ATM | 1.3 | 0.006 | | | | | | | | | |
| 9 | Mixture of | 2.8 | 0.006 | 25 | — | 5 | 54 | 7 | 50 | 614% | 120 | — |
| | 43% BGM | | | | | | | | | | | |
| | 57% BGF | | | | | | | | | | | |
| 10 | Mixture of | 4.4 | 0.010 | 40 | 91 | 35 | 67 | 13 | 90 | 592% | 230 | — |
| | 43% BGM | | | | | | | | | | | |
| | 57% BGF | | | | | | | | | | | |
| 11 | Mixture of | 4.6 | 0.010 | 40 | 90 | 48 | 73 | 20 | 115 | 475% | 280 | 19 |
| | 86% BGM | | | | | | | | | | | |
| | 14% BGF | | | | | | | | | | | |
| 12 | 100% BGF | 4.6 | 0.010 | 60 | 95 | 31 | 66 | 14 | 53 | 279% | 220 | 20 |

Processing torque measured upon (silane+peroxide) blend addition in the HDPE melt at 200° C. increases proportionally in the following order:

γ-MTM (Example C4)<VTM (Example C3)<γ-ATM (Example 4)<α-ATM (Example 7) when comparing these silanes at approximately equimolar concentrations. Intermediate torque increase between γ-ATM and α-ATM was observed when a mixture of both these silanes (0.5:0.5 mole equivalents each) was used (Example 8). Significant torque increases were also observed for the series of examples where either bis-(γ-trimethoxysilylpropyl)fumarate silane (Example 12) or mixtures with bis-(γ-trimethoxysilylpropyl)maleate silane (Examples 10 and 11) were used. The larger torque increases observed with γ-ATM, α-ATM and bis-(γ-trimethoxysilylpropyl)fumarate/maleate silane isomers are signs of enhanced grafting of the silane to the polyethylene chain during reactive mixing process. We believe that the presence of the carboxylic acid groups enables a more effective delocalization of the electron radical formed upon peroxide decomposition compared to VTM and that the improved grafting efficacy observed was a consequence. Although γ-MTM also contains a carboxylic acid group next to the carbon-carbon double bond, the methyl group in the alpha position may cause either steric hindrance or electron donating effect; hence poor grafting to HDPE occurs in the processing conditions used. We believe that methacrylic acid analogs of fumaric and maleic acids with a methyl substituent at the double bond, i.e., citraconic, mesaconic and itaconic acids, will also reduce the grafting yield to HDPE.

Grafting yield increases from 85% with VTM (Example C3), up to 95-100% with either γ-ATM (Examples 3 and 4) or α-ATM (Examples 5 to 7), showing the benefit of acryloxy-functional silane against VTM. On the other hand grafting yields were lower when γ-MTM was used (Example C4). Although a mixture of both bis-(γ-trimethoxysilylpropyl)fumarate/maleate silane isomers was used in Example 10, the grafting yield was also higher than for VTM in Example C3. When the purified version of either bis-(γ-trimethoxysilylpropyl)fumarate silane or bis-(γ-trimethoxysilylpropyl)maleate silane was used (Example 12 or 11), grafting yields were superior and in the range 90-95%.

Initial gel content is lower for VTM (Example C3) in comparison to acryloxy-silane grafted HDPE specimens (Examples 3 to 8). Initial gel content of the Example 10 specimen prepared with the mixture of both bis-(γ-trimethoxysilylpropyl)fumarate/maleate silane isomers was quite high too. When a purified version of bis-(γ-trimethoxysilylpropyl)maleate silane was used (Examples 11), initial gel content was the highest, with a value close to 50%. Initial gel content was close to zero in Example C4 with γ-methacryloxypropyltrimethoxysilane. These observations indicate that the improved grafting yield obtained with acryloxy- or maleate- or fumarate-functional silane caused an acceleration of the crosslinking process of the PEX specimens, already before any curing process step occurred.

Gel content after 24 hours curing underwater at 95° C. in the presence of 1% acetic acid are all close to the minimum 65% desired for crosslinked polyethylene water pipes for the Examples prepared with 0.010 to 0.013 mole % of the various silanes of the present invention (Examples 3 to 12). On the other hand, the gel content remains below 60% in Example C4 with 0.010 mole % γ-MTM.

Comparison of elastic shear modulus, G′@12%strain, measured after 3 hours curing against initial values measured on specimens taken immediately after compounding in the roller blade mixer, shows γ-ATM and α-ATM grafted HDPE specimens (Examples 3 to 8) crosslinking significantly faster than VTM (Example C3).

Silane grafted HDPE specimens with bis-(γ-trimethoxysilylpropyl)fumarate and/or maleate isomers (Examples 9 to 12) are crosslinking even faster. On the other hand elastic shear modulus remains extremely low for Example C4 where γ-MTM was used, even lower than Example C3.

Repeating the Example 11 in absence of DOTDL catalyst addition at the end of the compounding step as described for Example 1, was showing that similarly high gel content and G′ values can be obtained.

A good correlation was also observed between elastic shear modulus, G′@12% strain, measured after 24 hours curing and the corresponding gel content values.

Replacing VTM with an acryloxy-silane was shown to decrease significantly the energy of activation of the crosslinking reaction per mole of trimethoxysilyl groups present on each silane used in the Examples of Table 2 down from 81 kJ/mole with VTM (Example C3) to 29 kJ/mole with γ-ATM (Example 3) and 27 kJ/mole with α-ATM (Example 6). Further decreases down to ˜20 kJ/mole of the energy of activation of the crosslinking reaction were observed for bis-(γ-trimethoxysilylpropyl)fumarate and maleate silanes (Examples 11 and 12).

The decreases of energy of activation of crosslinking and the acceleration factors observed for reaching maximum degree of crosslinking in the cured specimens were therefore significant for the series of examples where acryloxy-silanes or bis-(γ-trimethoxysilylpropyl)fumarate and maleate silanes, and mixtures of them, were used in comparison to VTM (Example C3).

### EXAMPLES 13 TO 20 AND COMPARATIVE EXAMPLE C5

Grafted polyethylene specimens were prepared in a twin screw extruder using various silanes and peroxides in the amounts shown in Table 3. About 97% by weight Lupolen® 5031LQ449K high density polyethylene (HDPE) pellets were compounded with the silane and peroxide in a twin screw extruder at 200° C. in presence of 0.05% by weight Irganox 1330 antioxidant. The melt flow rate (2.16 kg/190° C.) of the grafted polyethylene was measured and is shown in Table 3.

TABLE 3

| | | Silane | Silane | | Peroxide | Peroxide | Melt flow |
|---|---|---|---|---|---|---|---|
| | | conc. | Conc | | conc. | conc. | Rate |
| Example | Silane | (wt %) | (mole %) | Peroxide | (wt %) | (mole %) | (g/10 min) |
| C5 | VTM | 1.7 | 0.012 | Luperox 101 | 0.09 | 0.00032 | 51.0 |
| 13 | γ-ATM | 2.3 | 0.0097 | Luperox 101 | 0.09 | 0.00032 | 27.9 |
| 14 | γ-ATM | 2.3 | 0.0097 | Trigonox 301 | 0.19 | 0.00029 | 26.7 |
| 15 | γ-ATM | 2.3 | 0.0097 | Trigonox B | 0.09 | 0.00063 | 8.4 |
| 16 | α-ATM | 2.0 | 0.0097 | Luperox 101 | 0.09 | 0.00032 | 8.3 |
| 17 | α-ATM | 2.0 | 0.0097 | Trigonox 301 | 0.23 | 0.00035 | 7.7 |
| 18 | α-ATM | 2.0 | 0.0097 | Trigonox B | 0.09 | 0.00063 | 6.4 |
| 19 | γ-ATM | 1.1 | 0.0048 | Luperox 101 | 0.09 | 0.00032 | 9.3 |
| | α-ATM | 1.0 | 0.0048 | | | | |
| 20 | γ-ATM | 1.1 | 0.0048 | Luperox 101 | 0.09 | 0.00032 | 21.5 |
| | α-AMM | 0.8 | 0.0048 | | | | |

The grafted polyethylene produced in each of Examples 13 to 20 and Comparative Example C5 was chopped into pellets and mixed at 200° C. with 2.5% by weight of a masterbatch of 0.3% by weight dioctyltin dilaurate catalyst in polyethylene in a single screw extruder of length/diameter, L/D 24, and extruded as pipe of wall thickness 2 mm and diameter 16 mm.

Although melt flow rate is decreased significantly when replacing VTM silane (Comparative Example C5) with either γ-ATM (Examples 13-15) or a-ATM (Examples 16-18), or mixture of both (Example 19), no difficulties were encountered during pipe extrusion using these silane-grafted HDPE samples. The decreases of melt flow rate are in agreement with the processing torques increases observed in the prior series of corresponding Examples shown in Table 2, and confirm the enhanced grafting of the silane to the polyethylene chain during the reactive extrusion process.

Samples of pipe were cured for 8 hours under steam at 110° C., or for 7, 14 or 28 days at ambient atmospheric conditions and were analyzed for gel content as described above. The results are shown in Table 4.

TABLE 4

| | Gel content | Gel content | Gel content | Gel content | Gel content |
|---|---|---|---|---|---|
| | Initial | 8 hours/110° C. | 7 days | 14 days | 28 days |
| Example | (%) | (%) | ambient (%) | ambient (%) | ambient (%) |
| C5 | 8 | 70 | 31 | 40 | 42 |
| 13 | 21 | 65 | 36 | 42 | 44 |
| 14 | 13 | 65 | 37 | 42 | 43 |
| 15 | 20 | 65 | 38 | 45 | 46 |
| 16 | 29 | 63 | 43 | 50 | 52 |
| 17 | 31 | 64 | — | — | — |
| 18 | 34 | 65 | 40 | 45 | 47 |
| 19 | 30 | 65 | — | — | — |
| 20 | 13 | 58 | 27 | 32 | 35 |

As in prior examples, initial gel content was the lowest for VTM (Comparative Example C5), while it increases for γ-ATM (Examples 13-15), α-ATM (Examples 16-18), and mixture of both (Example 19). Gel content measurements made after a curing cycle of 8 hours under steam water at 110° C. uncover the fact that the desired 65-75% gel content is reasonably well reached when either VTM or γ-ATM or α-ATM or a mixture of γ-ATM and α-ATM was used. Increases of the gel content upon ambient atmospheric conditions storage were observed for the Examples of the invention compared to the Comparative Example. After 28 days curing, values of about 50% gel content were obtained for α-ATM (Examples 16 and 18) and about 45% for γ-ATM (Examples 13-15) in comparison to 42% for the VTM reference (Comparative Example C5).

Other samples of pipe were cured for 24 hours underwater at 95° C. These pipes were tested for their key organoleptic properties, i.e., Total Organic Carbon (TOC) content and Threshold Odor Number (TON) values determined according to EN1622 standard, “Water analysis: Determination of the threshold odour number (TON) and threshold flavour number (TFN)”. The principle of the test consists in circulating water at 60° C. in pipe specimens for seven days. A water extract is then analyzed by gas chromatography (GCMS) for its TOC and by panellists for its TON. Results obtained are given in Table 5 below. The TOC values are expressed in mg/m².day. The TON values indicate the dilution factor applied to the water extract to prevent panellist smelling any odorous component from the water extract. The lower the dilution e.g. 2 being the minimum considered by the rating system in EN1622 standard, better is the result and the quality of the pipe for being use in drinking water distribution.

TABLE 5

| Example | TOC (mg/m² · day) | TON |
|---|---|---|
| C5 | 13.8 | 8-16 |
| 13 | 3.4 | 4 |
| 14 | 8.7 | 4 |
| 15 | 8.7 | 2 |
| 16 | 3.1 | 4 |
| 18 | 4.1 | 2-4 |
| 19 | 6.6 | 4-8 |
| 20 | 7.4 | 4 |

The ultimate targets for TOC and TON are to be the lowest possible after seven days extraction by water at 60° C. In order to reduce TOC and TON, fabricators are obliged to flush their pipe for several days underwater at high temperature. From the series of results displayed in Table 5, after 24 hours flushing underwater at 90° C., the organoleptic properties (TOC, TON) of the pipes produced according to the invention were significantly improved. Replacing VTM silane (Comparative Example C5) with either γ-ATM silane (Examples 13-15), or α-ATM (Examples 16 and 18), or mixture of both γ-ATM and α-ATM silanes (Example 19) as well as mixture of γ-ATM and α-AMM silanes (Example 20), significantly reduced TOC and TON values were observed.

### EXAMPLES 13A TO 20A AND COMPARATIVE EXAMPLE C5A

2 mm thickness molded plate samples of silane-grafted polyethylene were made from the compositions described in Examples 13 to 20 and Comparative Example C5 using the procedure of used for Examples 3 to 12 and Comparative Example C3 and C4. The silane-grafted polyethylene samples were crosslinked by immersion in 1% aqueous acetic acid at 95° C. for 3 or 24 hours. Elastic shear modulus (G′) was measured as described above and the value at 12% strain, G′@12% strain is recorded in Table 6. The activation energy of crosslinking was calculated from Arrhenius plots of G′@12% strain measurements made as a function of time underwater at temperatures of 30° C., 55° C. and 95° C. and is recorded in Table 6.

TABLE 6

| | | | | | | | G′ @ | | Activation |
|---|---|---|---|---|---|---|---|---|---|
| | | | | | G′ @ | G′ @ | 12% strain; | G′ @ | Energy Of |
| | | Silane | | Peroxide | 12% strain; | 12% strain; | Increase | 12% strain; | cross- |
| | | conc. | | conc. | Initial | 3 hrs | 3 hrs vs. | 24 hrs | linking |
| Example | Silane | (wt %) | Peroxide | (wt %) | (kPa) | (kPa) | initial (%) | (kPa) | (kJ/mole) |
| C5A | VTM | 1.7 | Luperox | 0.09 | 19 | 34 | 79% | 220 | 72 |
| | | | 101 | | | | | | |
| 13 A | Γ-ATM | 2.3 | Luperox | 0.09 | 25 | 56 | 124% | 190 | 32 |
| | | | 101 | | | | | | |
| 14 A | Γ-ATM | 2.3 | Trigonox | 0.19 | 27 | 67 | 148% | 190 | — |
| | | | 301 | | | | | | |
| 15 A | Γ-ATM | 2.3 | Trigonox | 0.09 | 35 | 80 | 129% | 200 | — |
| | | | B | | | | | | |
| 16 A | α-ATM | 2.0 | Luperox | 0.09 | 47 | 123 | 162% | 210 | 23 |
| | | | 101 | | | | | | |
| 17 A | α-ATM | 2.0 | Trigonox | 0.23 | 51 | 136 | 167% | 210 | — |
| | | | 301 | | | | | | |
| 18 A | α-ATM | 2.0 | Trigonox | 0.09 | 52 | 146 | 181% | 230 | — |
| | | | B | | | | | | |
| 19 A | γ-ATM | 1.1 | Luperox | 0.09 | 53 | 128 | 142% | 180 | 25 |
| | α-ATM | 1.0 | 101 | | | | | | |
| 20 A | γ-ATM | 1.1 | Luperox | 0.09 | 25 | 65 | 160% | 150 | 34 |
| | α-AMM | 0.8 | 101 | | | | | | |

As for Examples 3 to 12, elastic shear modulus measured after 3 hours curing against initial values measured on specimens before they were exposed to any curing step shows γ-ATM (Examples 13A-15A) and α-ATM (Examples 16A-18A) grafted polyethylene crosslinking significantly faster than VTM reference system (Example C5A).

As found in Examples 3 to 12, replacing the vinyl-silane (VTM) with acryloxy-silanes was shown to decrease significantly the energy of activation of the crosslinking reaction from 72 kJ/mole (Comparative Example C5A) down to 32 kJ/mole with γ-ATM (Example 13A), and 23 kJ/mole with α-ATM (Example 16A). When a mixture of acryloxysilanes, either γ-ATM and α-ATM (Example 19A), or γ-ATM and α-AMM (Example 20A) was used, the energy of activation of the crosslinking reaction was, respectively, 25 and 34 kJ/mole. All values of the Examples were significantly lower than for the VTM reference system (Comparative Example C5A), and in agreement with the corresponding Examples 3 to 12 and Comparative Example C3, respectively, of Table 2.

### EXAMPLES 21 AND 22 AND COMPARATIVE C6

Silane-grafted-polyethylene (PEX-b) specimens were prepared according to formulation displayed in table 7 and the compounding process described in Example 1 and below. The silane used was the γ-acryloxypropyltrimethoxysilane (γ-ATM) (FIG. 1).

In Examples 21 and 22, a silanol end capped resin (MQ1601 available from Dow Corning) was added in the crosslinking step together with the catalyst/antioxidant masterbatch. The same example according to the invention was repeated but without addition of silanol end-capped resin. Results are presented as “Comparative C6”.

The MQ1601 resin was in a solid form, characterized by ˜4 w % silanol content that were available for crosslinking with alkoxysilyl groups initially grafted onto the polyethylene (HDPE). The mole ratio between the amount of silanols from the MQ1601 resins and the amount of trimethoxysilyl groups from the silane-grafted HDPE used in the examples described of Table 7 was SiOH:˜Si(OMe)₃ (6:1).

Compounding was carried out in a Brabender Plastograph®350S mixer equipped with roller blades. Rotation speed was 100 rpm, and initial temperature of the chamber was 200° C. Torque and temperature of the melt were monitored for controlling the reactive mixing process of the ingredients. Total mixing time was 8 minutes, with a sequence of addition of the various ingredients in the mixer as follow, i.e.,
1. Loading the HDPE pellets, mixing for 2 minutes;
2. Loading the silane and the peroxide pre-adsorbed on the first half of porous HDPE pellets, mixing for 2 minutes;
3. Loading the antioxidants pre-adsorbed on the second half of porous HDPE pellets, the Nyflex processing oil and the MQ1601 solid resin (examples 21 and 22), mixing for 4 minutes;
4. Dropping batch and casting into 2 mm thickness plates on Agila®PE30 press at 200° C. for 5 minutes before cooling down to ambient temperature for 2 minutes.

The molded plates were then stored in a desiccator at 23° C. and 20% relative humidity conditions before further testing was carried out.

Test specimens of 30 mm diameter and 2 mm thickness were cut into the casted plates obtained after compounding, then cured underwater at 95° C. for periods of time from 0 to 24 hours for measuring the evolution of crosslinking in the material as a function of time.

Gel content was determined using method ISO 10147 “Pipes and fittings made of crosslinked polyethylene (PEX)—Estimation of the degree of crosslinking by determination of the gel content”. The degree of crosslinking is expressed as the percentage by mass of the insoluble material. Gel contents were measured only before and after crosslinking underwater at 95° C. with 1% acetic acid as condensation catalyst for 24 hours (Table 8). The addition of MQ1601 resin was to certain extent increasing both the initial and the final gel content in the material.

In order to determine the benefits in terms of rate of acceleration of the crosslinking process in silane-grafted-HDPE compound, elastic shear modulus (G′) measurements were carried out on an Advanced Polymer Analyzer APA2000®. 3.2 g specimens were analyzed above their melting point, at temperature of 180° C. Elastic shear modulus (G′) was recorded upon strain sweep under constant oscillating conditions (0.5 Hz). Recording the elastic shear modulus (G′), viscous shear modulus (G″), and Tan δ on a range of strain from 1 to 100% takes approximately 5 minutes. From the various plots of G′ as a function of percentage strain, the values at 12% strain (G′@12% strain) were all in the linear viscoelastic region. The G′@12% strain value was therefore selected in order to follow the increase in elastic shear modulus as a function of time curing of the specimens described in the Examples 21 and 22 (FIG. 2). Curing conditions were 95° C. underwater with 1% acetic acid as condensation catalyst.

The plots of G′@12% strain increase with time curing are shown in FIG. 2. Against the comparative example C6, the examples 21 and 23 illustrate the benefit adding MQ1601 resin into the compound for accelerating the speed of crosslinking as well as to certain extend the final degree of crosslinking density into the material after the complete curing cycle underwater at 95° C. Like for the gel content measurements, after 24 hours curing underwater at 95° C., almost complete crosslinking occurred in the specimens.

TABLE 7
Ingredients and formulations

| | | | | | Comparative | |
|---|---|---|---|---|---|---|
| | Example 21 | | Example 22 | | Example C6 | |
| | | Weight | | Weight | | Weight |
| Ingredients | w % | (g) | w % | (g) | w % | (g) |
| HDPE LUPOLEN 5031 LQ 449 K | 83.2% | 199 | 83.2% | 199 | 86.1% | 206 |
| Anti-Oxidant Irgafox 168 | 0.10% | 0.24 | 0.10% | 0.24 | 0.10% | 0.25 |
| Anti-Oxidant Hostanox 1010 | 0.05% | 0.12 | 0.05% | 0.12 | 0.05% | 0.12 |
| Accurel XP200 (porous HDPE) | 8.32% | 20 | 8.32% | 20 | 8.61% | 21 |
| Peroxide Luperox 101 | 0.11% | 0.26 | 0.11% | 0.26 | 0.11% | 0.27 |
| 3-Acryloxypropyl trimethoxy silane | 2.89% | 6.9 | 2.89% | 6.9 | 3.01% | 7.2 |
| MQ 1601 Solid Resin | 3.33% | 8.0 | 3.33% | 8.0 | none | none |
| Oil Nyflex 222B | 2.0% | 5 | 2.0% | 5 | 2.07% | 5 |

TABLE 8
Gel content measured according to ISO10147 standard test method before
and after crosslinking underwater at 95° C. for 24 hours with 1%
acetic acid of formulation of Table 7

| | | | Comparative |
|---|---|---|---|
| | Example 21 | Example 22 | Example C6 |
| Gel content | 29 | 34 | 24 |
| before curing (%) | | | |
| Gel content after 24 hours | 65 | 66 | 60 |
| underwater @95° C. | | | |

### EXAMPLES 23 AND 24 AND COMPARATIVE EXAMPLES C7 AND C8

A repeat of examples 21 and 22 was carried out according to the process used in example 13, also known as Sioplas® process used for producing PEX-b pipes. In Examples 23 and 24, a silanol end capped resin was added after the initial grafting reaction while in “Comparative C7 and C8”, a silane-grafted-polyethylene (PEX-b) specimen was prepared according to the invention as in Examples 23 and 24 without addition of silanol end-capped resin.

A first masterbatch was prepared in a twin screw extruder by grafting, respectively, 2.04 and 2.72% by weight of γ-ATM silane to HDPE in presence of 0.07% by weight of Trigonox®B peroxide. In a second step, 93.5% by weight of γ-ATM-grafted HDPE compound was extruded in a single screw extruder into 2 mm thickness bands in presence of a 2.5% by weight of a catalyst masterbatch and 4% by weight MQ1601 resin. The rates of crosslinking as a function of time curing underwater at 95° C. were again monitored by measuring the increase of elastic shear modulus (G′) at 12% strain, similarly to the previous series of specimens. Results displayed in FIG. 3 show the relative increase of elastic shear modulus (G′) as a function of time (t) curing underwater at 95° C. against initial value at time zero (G′₀). The results confirm the effect of MQ1601 addition for accelerating the rate of crosslinking in the material.

In absence of MQ1601 resin (Comparative Examples C7 and C8), the relative increase of G′ with time is quite independent from γ-ATM concentration. When adding 4% by weight MQ1601 resin (Examples 23 and 24), a faster increase of G′ was observed with 2.0% γ-ATM against 2.7%. This may be explained since rate of crosslinking, or cure-in-depth at any given point of time, depends upon the volume of alkoxysilyl-functional material which reacts with water and/or silanol present in the system. Larger is the quantity of silanols brought by the MQ1601 resin addition against the quantity of alkoxysilyl-groups grafted to the HDPE resin, faster will be the rate of cure-in-depth within the material exposed to water

### FIGURES

FIG. 1: Chemical name and formula of γ-acryloxypropyltrimethoxysilane used for grafting
to high-density polyethylene (HDPE) resin.

| Name | Formula |
|---|---|
| γ-acryloxypropyltrimethoxysilane (γATM) | 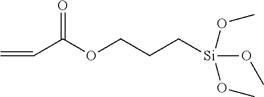 |

### EXAMPLES 25 TO 28 AND COMPARATIVE EXAMPLES C9 AND C10

Grafted polyethylene specimens were prepared in a twin screw extruder according to the process used in example 13. About 95% by weight Innovene® A4040 medium density polyethylene (MDPE) pellets were compounded with the silane and peroxide in a twin screw extruder at 200° C. in presence of processing aid and antioxidants according to quantities indicated in the table 9 for obtaining each of the Examples 25 and 27 and Comparative Example C9.

The grafted polyethylene produced in each of Examples 25 and 27 and Comparative Example C9 was chopped into pellets and mixed at 200° C. with 3% by weight of a masterbatch of 0.7% by weight dioctyltin dilaurate catalyst in polyethylene in a single screw extruder of length/diameter, L/D 24, and extruded as pipe of wall thickness 2 mm and diameter 16 mm.

The grafted polyethylene produced in each of Examples 26 and 28 and Comparative Example C10 was chopped into pellets and extruded as pipe of wall thickness 2 mm and diameter 16 mm in a single screw extruder of length/diameter, L/D 24.

Each pipe specimens of Examples 26 to 28 and Comparative Example C9 and C10 obtained were then tested for their gel content before and after different periods of time curing underwater at 90° C. The results are shown in table 10.

TABLE 9
Ingredients and formulations

| | Example | Example | Example | Example | Comparative | Comparative |
|---|---|---|---|---|---|---|
| | 25 | 26 | 27 | 28 | Example C9 | Example C10 |
| HDPE Eltex | 95 | 95 | 95 | 95 | 95 | 95 |
| A4040 | | | | | | |
| Irganox 1330 | 0.08 | 0.08 | 0.08 | 0.08 | 0.08 | 0.08 |
| Irganox 1076 | 0.04 | 0.04 | 0.04 | 0.04 | 0.04 | 0.04 |
| Irgafos 168 | 0.03 | 0.03 | 0.03 | 0.03 | 0.03 | 0.03 |
| Processing Aid | 1 | 1 | 1 | 1 | 1 | 1 |
| MB50-514 | | | | | | |
| αATM silane | 2.46 | 2.46 | — | — | — | — |
| γATM silane | — | — | 2.46 | 2.46 | — | — |
| VTM silane | | | | | 1.52 | 1.52 |
| Trigonox B | 0.043 | 0.043 | 0.043 | 0.043 | 0.080 | 0.080 |
| peroxide | | | | | | |
| Catalyst DOTDL | 0.021 | — | 0.021 | — | 0.021 | — |

TABLE 10
Gel content according to ISO10147 standard method as a function
of time curing underwater at 90° C. for examples of Table 9.

| | Example | Example | Example | Example | Comparative | Comparative |
|---|---|---|---|---|---|---|
| | 25 | 26 | 27 | 28 | Example C9 | Example C10 |
| Gel content (%), | 23 | 19 | 3 | 1 | 8 | 0 |
| initial | | | | | | |
| Gel content (%), | 41 | 40 | 36 | 4 | 35 | 0 |
| 1 hr/H₂O/90° C. | | | | | | |
| Gel content (%), | 60 | 59 | 57 | 9 | 57 | 1 |
| 4 hrs/H₂O/90° C. | | | | | | |
| Gel content (%), | 67 | 68 | 66 | 45 | 67 | 26 |
| 24 hrs/H₂O/90° C. | | | | | | |

In presence of DOTDL catalyst (Examples 25 and 27, and Comparative Example C9), gel content were almost all increasing similarly with time curing underwater at 90° C.

In absence of DOTDL catalyst, gel content was the lowest for comparative example C10 made with VTM silane. Examples 26 and 28 in which, respectively, αATM and γATM silanes were grafted to polyethylene, were both curing faster than with VTM silane.

However when comparing the evolution of gel content in Examples 25 and 26 on one hand, and in Examples 28 and 28 on the other hand, it is remarkable to notice that the rate of curing was independent from the presence or absence of condensation catalyst, DODTL, in Examples 25 and 26. It is therefore preferable to use αATM instead of γATM silane in order to develop a silane-grafted-polyethylene compound that will not require the use of a condensation catalyst, e.g., DOTDL, which brings advantages in terms of cost and eco-toxicity of the finished goods.

1. A process for grafting hydrolysable silane groups to polyethylene, the process comprising reacting polyethylene at a temperature above 140° C. with an unsaturated silane, having at least one hydrolysable group bonded to Si, in the presence of a compound or means capable of generating free radical sites in the polyethylene, characterized in that the silane has the formula R″—CH═CH—Z (I) or R″—C≡C—Z (II) in which Z represents an electron-withdrawing moiety substituted by an —SiRₐR′₍₃₋ₐ₎ group wherein R represents a hydrolysable group; R′ represents a hydrocarbyl group having 1 to 6 carbon atoms; a has a value in the range 1 to 3 inclusive; and R″ represents hydrogen or a group having an electron withdrawing effect or any other activation effect with respect to the —CH═CH— or —C≡C— bond.

2. A process according to claim 1 characterised in that each group R in the unsaturated silane (I) or (II) is an alkoxy group.

3. A process according to claim 1 characterised in that the unsaturated silane (I) or (II) is partially hydrolyzed and condensed into oligomers.

4. A process according to claim 1 characterised in that the silane has the formula R″—CH═CH—X—Y—SiRₐR′₍₃₋ₐ₎ (III) or R″—C≡C—X—Y—SiRₐR′₍₃₋ₐ₎ (IV) in which X represents a chemical linkage having an electron withdrawing effect with respect to the —CH═CH— or —C≡C— bond; and Y represents a divalent organic spacer linkage comprising at least one carbon atom separating the linkage X from the Si atom.

5. A process according to claim 4 characterised in that the silane has the formula R″—CH═CH—X—Y—SiRₐR′₍₃₋ₐ₎ (III) and the moiety R″—CH═CH—X—Y— is an acryloxyalkyl group.

6. A process according to claim 5 characterised in that the unsaturated silane (I) comprises γ-acryloxypropyltrimethoxysilane.

7. A process according to claim 5 characterised in that the unsaturated silane (I) comprises acryloxymethyltrimethoxysilane.

8. A process according to claim 5 characterised in that the unsaturated silane (I) comprises a blend of γ-acryloxypropyltrimethoxysilane with acryloxymethyltrimethoxysilane, or a blend of γ-acryloxypropyltrimethoxysilane and/or acryloxymethyltrimethoxysilane with vinyltrimethoxysilane.

9. A process according to claim 4 characterised in that the group R″ in the unsaturated silane (I) or (II) is an electron withdrawing group of the formula —X—Y—SiRₐR′₍₃₋ₐ₎.

10. A process according to claim 9 characterised in that the unsaturated silane (I) comprises a bis(trialkoxysilylalkyl)fumarate and/or a bis(trialkoxysilylalkyl)maleate.

11. A process according to claim 1 characterised in that the unsaturated silane (I) or (II) is present at 0.5 to 15% by weight based on the total composition during the grafting reaction.

12. A process according to claim 1 characterised in that the compound capable of generating free radical sites in the polyethylene is an organic peroxide and is present at 0.01 to 0.5% by weight based on the total composition during the grafting reaction.

13. A process according to claim 1 characterised in that a silanol-containing silicone compound is added after the grafting reaction.

14. A process according to claim 13 characterized in that the silanol containing silicone is an MQ solid resin containing from 2 to 6% by weight of silanol groups.

15. A process according to claim 14 characterised in that the silanol-containing compound is present at 1% to 10% by weight based on the total composition obtained after the grafting reaction.

16. A process according to claim 1 characterised in that the unsaturated silane (I) or (II) is deposited on a filler before being reacted with polyethylene.

17. A polyethylene grafted with hydrolysable silane groups, characterized in that the polyethylene contains grafted moieties of the formula R″—CH(PE)-CH₂—X—Y—SiRₐR′₍₃₋ₐ₎ and/or grafted moieties of the formula R″—CH₂—CH(PE)-X—Y—SiRₐR′₍₃₋ₐ₎ wherein R represents a hydrolysable group; R′ represents a hydrocarbyl group having 1 to 6 carbon atoms; a has a value in the range 1 to 3 inclusive; X represents a chemical linkage having an electron withdrawing effect with respect to the —CH═CH— or —C≡C— bond; Y represents a divalent organic spacer linkage comprising at least one carbon atom separating the linkage X from the Si atom; R″ represents hydrogen or a group of the formula —X—Y—SiRₐR′₍₃₋ₐ₎; and PE represents a polyethylene chain.

18. (canceled)

19. A process for cros slinking polyethylene, characterized by exposing the grafted polyethylene according to claim 17 to moisture to crosslink the grafted polyethylene, optionally in the presence of a silanol condensation catalyst.

20. A process according to claim 19 characterised in that the grafted polyethylene is shaped into an article and is subsequently crosslinked by exposure to moisture.

21. A process according to claim 20 characterised in that the grafted polyethylene is shaped into a pipe and is crosslinked by water flowing through the pipe.
